(19) United States
(12) Patent Application Publication
(10) Pub. No.: US 2005/0173969 A1
(43) Pub. Date: Aug. 11, 2005

(54) Extensional hubcap docking structure

(75) Inventor: Ming-Fang Wang, Tainan Hsien (TW)

Correspondence Address: BACON & THOMAS, PLLC, 625 SLATERS LANE, FOURTH FLOOR, ALEXANDRIA, VA, 22314, US

(73) Assignee: Kuan Hsings Enterprise Corp., Tainan Hsien (TW)

(21) Appl. No.: 10/774,391

(22) Filed: Feb. 10, 2004

(51) Int. Cl. B60B 7/12

(52) U.S. Cl. 301/37.34

(57) ABSTRACT

An extensional hubcap docking structure comprised of anchoring mounts disposed on the back surface of a hubcap and clip components coupled onto the anchoring mounts. Elastic components are situated between the hubcap anchoring mounts and the clip components. When the hubcap is fully installed onto the tire wheel and the hubcap is subjected to an outward force that displaces the anchoring mounts outward, the elastic components deform and shift such that the hubcap is kept safely and tightly positioned on the wheel rim.

### BACKGROUND OF THE INVENTION

1) Field of the Invention

The invention herein relates to automotive parts and accessories, specifically an extensional hubcap docking structure having structural simplicity, wherein when a hubcap so-equipped is installed onto a tire wheel and subjected to an outward force, an appropriate degree of spring-loaded extension is provided for to thereby prevent hubcap damage.

2) Description of the Related Art

As indicated in FIG. 1, a conventional hubcap 1 typically consists of a round contoured surface 11 having a plurality of differently shaped reticulations 12 and a plurality of clip members 13, each having a crook 14 at their free extremities 14, that are arrayed at equal intervals apart on the back surface of the hubcap 1, with the clip member 13 crooks 14 providing for placement on a steel ring 15, the steel ring 15 utilized to insertionally retain all of the clip members 13 along the outer diameter of a wheel 2.

Since the main purpose of such a conventional hubcap 1 is to conceal the unattractive wheel 2, the design of the round contoured surface 11 is such that its outer diameter is equal to or slightly smaller than the circumferential extent of the rim 21, which only accomplishes the objective of covering the wheel 2. However, motor vehicles are virtually indispensable means of transportation and although the wheels 2 on which their tires 3 are mounted do not only facilitate the rotation of the tires 3, many vehicle drivers often replace original 13-inch wheels 2 with those of 14-inch specifications or move up from 14-inch to 15-inch ones in hopes of increasing mileage for the same number of revolutions. But given the wheel well area limitations of vehicle chassis, tire size cannot be increased indefinitely. Consequently, vehicle horsepower and torque allowing, as wheel dimensions are increased, if the maximum diameter at the tread pattern of a tire does not change, then the tire becomes correspondingly thinner, and many drivers are more interested in these thinner, low-profile tires. Even so, the desire for such tires of lesser thickness cannot be fulfilled for every driver unless a vehicle's engine is modified to achieve greater horsepower because the horsepower and torque of most vehicles at the time of factory release often does not allow for replacement wheels of larger dimensions. However, U.S. Pat. No. 6,575,537 (Double Deck Wheel Cover) provides a design in which after installing an enlarged circumference wheel cover, if tire pressure is insufficient and the distended tire is impacted, the wheel cover is capable of elastic extension. However, the design requires the use of an inner and an outer cover as well as insertion slots and tabs, while also having numerous retaining elastic members within the inner and outer cover which is not only structurally complex, but at the same time when users of such wheel cover only want an outer cover and do not need an inner cover, the patent cannot satisfy consumer requirements.

### SUMMARY OF THE INVENTION

The objective of the invention herein is to provide an extensional hubcap docking structure comprised of anchoring mounts disposed on the back surface of a hubcap and clip components coupled onto the anchoring mounts; elastic components are situated between the hubcap anchoring mounts and the clip components; when the hubcap is fully installed onto the tire wheel and the hubcap is subjected to an outward force that displaces the anchoring mounts outward, the elastic components deform and shift such that the hubcap is kept safely and tightly positioned on the wheel rim.

### BRIEF DESCRIPTION OF THE DRAWINGS

Other features and advantages of the present invention will become apparent in the following detailed description of the preferred embodiments, with reference to the accompanying drawings, in which:

FIG. 1 is a cross-sectional drawing of a conventional hubcap mounted on a tire rim structure.

FIG. 2 is an exploded drawing of the preferred embodiment docking structure of the invention herein.

FIG. 3 is a cross-sectional drawing of the preferred embodiment docking structure of the invention herein.

FIG. 4 is a partial drawing of the preferred embodiment shown in FIG. 3.

FIG. 5 is a cross-sectional drawing that illustrates the elastic movement of the preferred embodiment clip component of the invention herein.

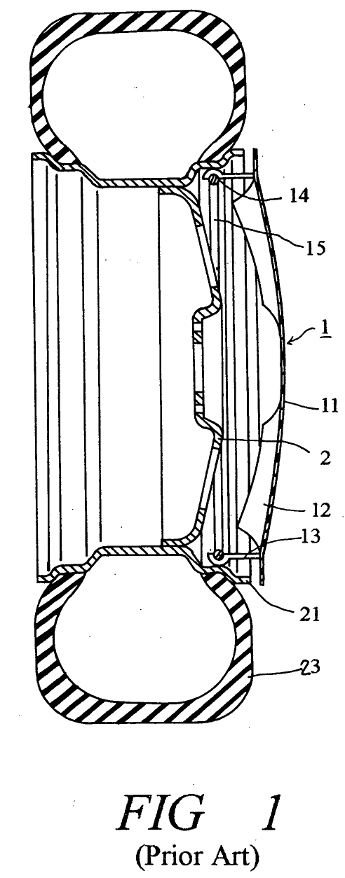

### DETAILED DESCRIPTION OF THE PREFERRED EMBODIMENTS

In the detailed description of the preferred embodiments, identical elements are indicated by the same reference numerals throughout the disclosure.

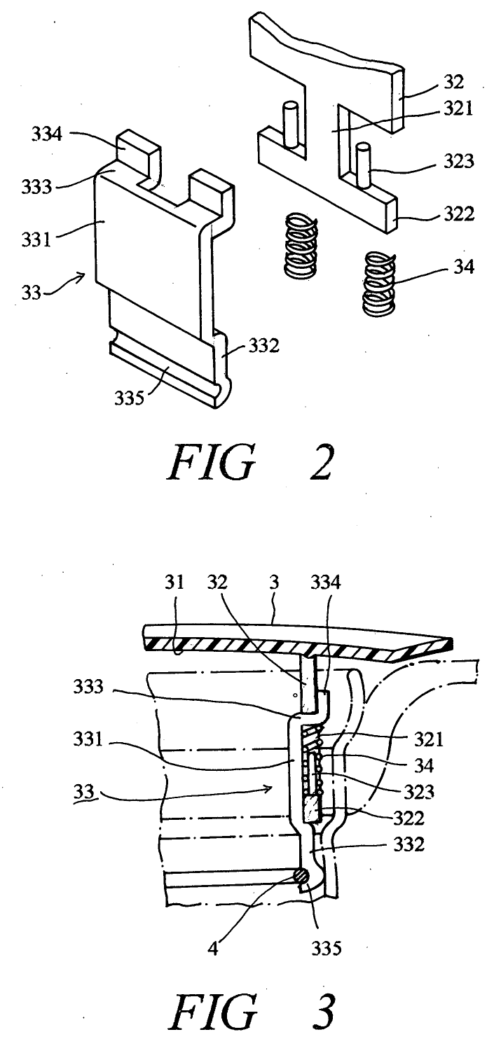

Referring to FIG. 2, the preferred embodiment hubcap of the invention herein has numerous structural components that are totally identical and, therefore, only a single structure will be elaborated below; the preferred embodiment docking structure of the invention herein consists of a hubcap 3, the back surface 31 of which has disposed:

An anchoring mount 32; the anchoring mount 32 has a support section 321, a suspension arm 322 is horizontally postured on the support section 321, and a pin 323 protrudes from the suspension arm 322 at each of the two sides of the support section 322 towards the anchoring mount 32.

A clip component 33 consisting of a backing seat 331, an inset seat 332 articulated at one end of the backing seat 331, a support seat 333 bent at the other end, two check seats 334 formed immediately thereafter at a suitable distance apart, and a latch seat 335 contoured into the inset seat 332.

A spring-type elastic component 34 is sleeved over each of the two pins 323 on the suspension arm 322 of the said anchoring mount 32 and the other extremity of each elastic component 34 is against the support seat 333 of the clip component 33.

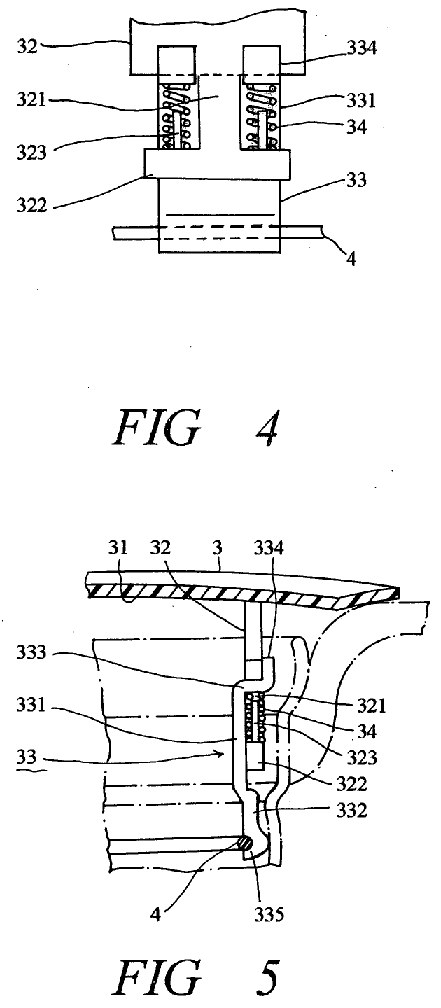

Referring to FIG. 3 and FIG. 4, the installation of the preferred embodiment of the invention herein consists of straddling the clip component 33 via its two check seats 334 across the two sides of the anchoring mount 32 support section 321, while angling the check seats 334 and the support seat 333 to insert them between the pins 323 and anchoring mount 32, following which the clip component 33 is correctly postured such that the backing seat 331 is against the anchoring mount 32 inner side, and such that the two check seats 334 each are against the anchoring mount 32 outer side, at which time the clip component 33 inset seat 332 engages the distal extremity of the anchoring mount 32, enabling the lengthwise conjoinment of the clip component 33 to the anchoring mount 32; the extremities of the two elastic components are then individually sleeved onto the pins 323 protruding from the support seat 333 of the anchoring mount 32 and the other extremities are against the support seat 333 of the clip component 33 support seat 333; and the latch seats 335 of a plurality of circularly arrayed clip components 33 are affixed to a steel ring 4, as would be the case for conventional hubcaps; as such, when fully installed onto tire wheel rims, if the tire pressure is insufficient, and the tire casing flattens and become laterally distended, the hubcap is subjected to an outward force that moves it slightly away from the anchoring mount 32, as indicated in FIG. 5, causing the compression of the elastic components 43 on the pins 322 situated between the support seats 33 and the anchoring mounts 32 such that the clip components 33 remain attached to the inner edge of the wheel, thereby keeping the hubcap safely and tightly positioned on the wheel.

The hubcap docking structure of the preferred embodiment is of a simple arrangement that averts hubcap dislodging when tire pressure is insufficient or when a flattened tire becomes laterally distended and, at the same time, since the extensional structure is entirely and purely derived from the design of the docking structure itself, the structural design does not affect the hubcap interior as is the case with the related art; furthermore, since the design of the hubcap does not necessitate an excessive quantity of additional parts and higher complexity, the packaging material and installation advantages of the present invention greatly exceeds that of the said double deck wheel cover.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. An extensional hubcap docking structure comprised of anchoring mounts disposed on the back surface of a hubcap and clip components coupled onto the anchoring mounts.
The features of which are that elastic components are situated between the said hubcap anchoring mounts and the said clip components; when the said hubcap is fully installed onto a tire wheel and the said hubcap is subjected to an outward force that displaces the said anchoring mounts outward, the said elastic components deform and shift such that the said hubcap is kept safely and tightly positioned on the wheel rim.

2. As mentioned in claim 1 of the extensional hubcap docking structure of the invention herein, each said anchoring mount has a support section and a suspension arm is on the said support section; each said clip component consists of a backing seat, an inset seat articulated at one end of the said backing seat, a support seat bent at the other end, two check seats formed immediately thereafter at suitable a distance apart, and a latch seat contoured into the said inset seat.

3. As mentioned in claim 1 of the extensional hubcap docking structure of the invention herein, the said elastic components are situated between the said suspension arm of the said anchoring mount and the said support seat of the said clip component.

4. As mentioned in claim 1 of the extensional hubcap docking structure of the invention herein, each of the said elastic components is sleeved onto a pin on the said suspension arm of the said anchoring mount.

5. As mentioned in claim 4 of the extensional hubcap docking structure of the invention herein, the said pin is disposed in pairs, each said pin protruding from the said suspension arm at the two sides of every said support section towards the said anchoring mount.
